(19) United States
(12) Patent Application Publication
(10) Pub. No.: US 2006/0135172 A1
(43) Pub. Date: Jun. 22, 2006

(54) Method for quality of service differentiation in packet-mode mobile communication networks

(76) Inventors: Francois Dronne, Sceaux (FR); Nathalie Beziot, Le Plessie Robinson (FR)

Correspondence Address: MILES & STOCKBRIDGE PC, 1751 PINNACLE DRIVE, SUITE 500, MCLEAN, VA, 22102-3833, US

(21) Appl. No.: 10/537,395

(22) PCT Filed: Aug. 5, 2004
(86) PCT No.: PCT/FR04/02095

§ 371 Date: Dec. 19, 2005

(30) Foreign Application Priority Data
Sep. 11, 2003 (FR) 0310709

(51) Int. Cl. H04Q 7/20

(52) U.S. Cl. 455/452.2

(57) ABSTRACT

The invention relates to a method for managing the quality of service that applies to a packet mode mobile communications network, in particular, characterised in that it includes, in the case of a network overload when accessing the resources of the network in order to execute a service for a network subscriber, a stage that consists in the following, at the level of each of the network nodes: determining an overall priority level for said access to resources, defined by a combination of at least one quality of service parameter related to the type of service and at least one quality of service parameter corresponding to the subscriber priority level, and applying at least one predefined quality of service process to the data stream that corresponds to said service, according to said determined overall priority level.

The invention relates, in a general manner, to the field of telecommunications and, in particular, to a method for differentiating the quality of service within the framework of mobile communications networks that use packet switching.

Within such a context, quality of service means the capacity of a service provided by a mobile communication network operator to adequately meet the requirements to satisfy its subscribers, in particular, in terms of network resource optimisation.

The method according to the invention is to be applied to mobile networks using GPRS or UMTS technology, standardised within the framework of the 3GPP standard. In order to avoid overloading the description, a glossary that includes the definition of all the acronyms used herein is provided at the end of the description, which the reader can refer to.

The GPRS standards specifies a new service for supporting packet mode data transmission over GSM and allows offering the subscribers of a mobile operator access to IP-based services (for example, electronic messaging, file download, Web site or WAP access, etc.) The data (transmitted in IP packets) can therefore be exchanged between servers belonging to an external network of the GPRS network, normally an Internet network, and the mobile telephone.

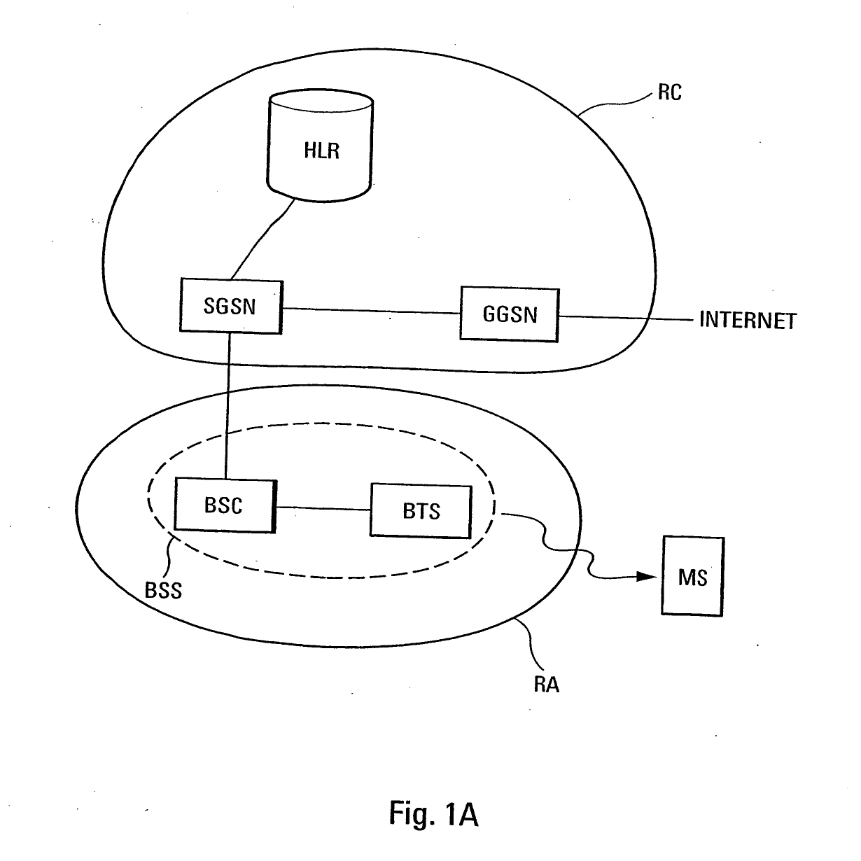

For this purpose, a radio channel is established between the mobile telephone and the radio access network, then the data stream is routed within the core network. Thus, in terms of architecture, the GPRS network comprises two main parts illustrated in FIG. 1A: the core network RC, which groups the network elements related to packet routing, and the access network RA, that establishes the radio link with the mobile telephones MS.

The access network RA groups the base transceiver station BTS and base station controller BSC entities. This set, called base station subsystem BSS, manages the radio resources of the GSM-type cellular telephony network using base transceiver stations and base station controllers. The role of the BSS is, in particular, to manage the establishment of a radio channel with the mobile telephone MS and store the quality of service data relative to a data transfer requested by the mobile telephone.

The core network RC, in turn, is constituted by the following network elements:

The HLR, which is a database that contains the profile of all the network subscribers and which is used to manage the mobile telephone subscribers. It contains, among other things, the quality of service data related to subscribers and services.

The SGSN, which is a network service node ensuring the management of the communication link with the access network. It stores the subscriber profile and controls the network resources requested by the subscriber.

The GGSN, which is a network service node serving as a gateway to ensure the interconnection with an external network, typically the Internet network.

The core network GPRS is therefore interconnected to the outside via a gateway, the service node GGSN, which contains the routing data that allows the mobile telephone to communicate with the external network, in particular the Internet network, whilst ensuring security. In order to be able to send data to the mobile telephone, the GGSN uses another service node, the SGSN, which manages mobility, in particular, authentication, encryption, and tracking of the mobile telephone when it travels. These network elements integrate IP router functions and constitute an IP network type network.

As regards to the mobile telephony standard UMTS, it can be considered as an extension of the GPRS network as defined above and has been designed to provide greater satisfaction, in particular, in term of throughput, for routing multimedia communications (Internet access, videoconferencing, video games, multimedia forum-type instant exchanges.) Currently, UMTS and GPRS are phased with different versions or releases, and, in particular, the version called Release 99, to which the description below makes particular reference.

With reference to FIG. 1B, regarding the access network part, called UTRAN for the UMTS standard, new transceiver base stations, called Node B, will replace the BTSs of the GPRS, and greater capacity base station controllers, called RNC, will replace the BSCs.

As regards to the core network RC within the framework of UMTS, it stores the elements that constitute the GPRS in a practical manner, whilst upgrading the SGSN and GGSN service nodes. The HLR is also upgraded by the introduction of new user profiles.

In Release 99, all the services are supported by four classes of traffic standardised as follows: “Conversational,” “Streaming,” “Interactive,” and “Background.”

The “Conversational” and “Streaming” classes are particularly designed to transport real time streams, such as voice or video. Nevertheless, as regards to the “Streaming” class, corresponding to a user viewing (or listening to) real time video (audio), there are less constraints on data transfer times than for the “Conversational” class.

The “Interactive” and “Background” classes correspond to non-real time services and are, in turn, designed to be used within the framework of traditional Internet applications, such as navigation, e-mail, and FTP applications. Because these classes are not in real time, they offer significantly better error rate owing to retransmission and encoding procedures.

It has been seen that the invention related to, in particular, the field of quality of service (QoS) management in GPRS or UMTS networks. Furthermore, it appears necessary, at this stage, to recall the main QoS parameters.

The QoS parameters of the GPRS or UMTS support service describe the service that the UMTS network provides to the support service user. The QoS profile, formed by the set of QoS parameters, specifies this service. Therefore, these standardised parameters allow defining the main characteristics of a data stream over the network, in particular in terms of throughput, traffic type, priority, etc. These QoS parameters are related to the type of stream that the subscriber subscribes to. If subscribers subscribes to several different streams, they will have several QoS profiles. This data is stored in the subscriber profile in the HLR and is transmitted, using different procedures, to the following entities: SGSN, GGSN, and BSS/RNC.

In fact, the QoS profile of a subscriber corresponds to the maximum authorised limit with respect to the specific values requested by the subscriber. The QoS profile can also correspond to a default profile configured by the operator.

The QoS parameters that are specified in a QoS profile are, in particular, as follows:

“Allocation Retention Priority”: this ARP parameter indicates the subscriber priority. It can have the values 1 (high priority) to 3 (low priority.) It is provided to the HLR for each PDP context to which a subscriber subscribes. It is defined as a priority for assigning/maintaining radio resources.

It should be noted that within the framework of the GPRS support service, this parameter is not transmitted to the BSS; therefore, it is only available at the SGSN and GGSN service node level.

On the other hand, within the framework of the UMTS support service, it is used in the SGSN, GGSN, and RNC of the UTRAN to give, among other things, priority to the activation of a PDP context. In the RNC, the ARP parameter includes four sub-parameters: “Priority Level,” “Pre-emption Capability,” “Pre-emption Vulnerability,” and “Queuing allowed.” It is the SGSN that, upon receiving this ARP parameter from the HLR, gives the values to the sub-parameters. Therefore, it then is the “Priority Level” sub-parameter that indicates the subscriber priority.

“Precedence Class”: this QoS parameter, defined initially in Release 97, indicates the priority of a subscriber when it is used. It can have the same values than those of the “Allocation Retention Priority” (ARP) parameter.

Thus, the previously described parameters “Precedence Class” and “Allocation Retention Priority” (or its sub-parameter “Priority Level”) relate equally to a data element that corresponds to the subscriber priority level.

“Traffic Class”: this QoS parameter indicates the priority related to the type of service. As indicated, in Release 99, all the services are supported by four traffic classes. Furthermore, this QoS parameter can have the values “Conversational” (high priority since the real time requirement is very important,) “Streaming,” “Interactive,” and “Background” (low priority.)

“Traffic Handling Priority” (THP): this QoS parameter allows specifying the priority level of the “Interactive” traffic class. This parameter can have three values.

From among these parameters, the following can also be stated for information purposes, since they are not used within the framework of this invention:

“Transfer Delay”: this QoS parameter indicates the maximum delay during a packet transfer. It is used only for priority services.

“Guaranteed bit rate”: this QoS parameter indicates the throughput during packet transfer. It is used only for real time services.

“Maximum bit rate”: this QoS parameter indicates the maximum throughput.

The set of QoS parameters indicated above are defined within the framework of the 3GPP telecommunications standard. Nevertheless, their use is not standardised.

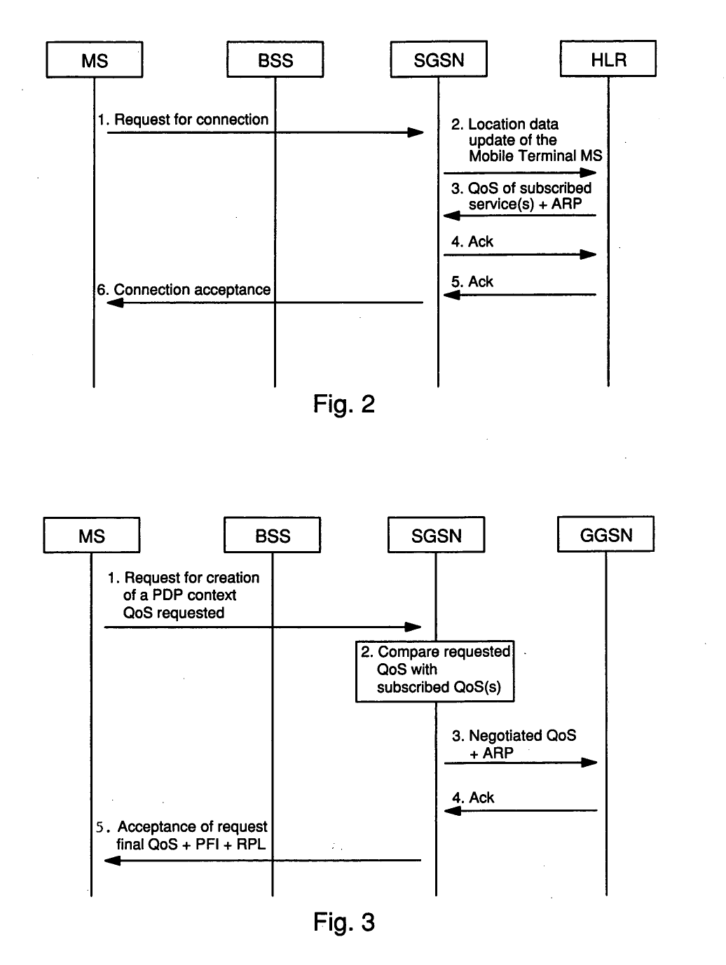

The main procedures implemented for accessing the GPRS service will now be described. These procedures are described with reference to FIGS. 2 and 3. The procedures described below allow the mobile telephone to connect to the network, reserve resources in the core network, exchange QoS parameters between entities, and establish the radio channel. Once all these procedures have been established, the subscriber will be able to transmit or receive data via the GPRS network.

Thus, to access the GPRS service, a mobile terminal MS must first connect to the network using a network connection method described with reference to FIG. 2. This method applies when subscribers enter the GPRS network coverage area, for example, when they turn on their mobile terminal. This method allows establishing a logical link between the mobile terminal MS and the SGSN service node.

During a first stage, the terminal MS requests the possibility of connecting to the GPRS network. This request is performed via the BSS and the local SGSN and includes data that allows locating the terminal, in particular, the IMSI number.

During a second stage, an exchange protocol, called a MAP protocol, is implemented between the SGSN and the HLR. In particular, the SGSN transmits, to the HLR, a location data update of the mobile terminal MS.

In the return direction, during a third stage, the HLR, owing to the location data update received, transfers to the SGSN, the subscriber data that describes the service(s) that the subscriber has a right to use, with, in particular, the QoS(s) that the subscriber is subscribed to (if the subscriber subscribes to several services,) and the ARP parameter(s).

During a fourth and fifth stage, each SGSN and HLR entity respectively sends an acknowledgement whose destination is the other entity. This terminates the data exchange protocol between these entities for connecting the terminal MS to the network.

Lastly, the SGSN sends a connection acceptance to the terminal MS via the BSS.

A procedure for creating a PDP context, consisting in the creation of a packet session, is described with reference to FIG. 3. It allows the mobile terminal to request the storage of a PDP context in the SGSN and GGSN and thus reserve resources in the core network for executing the service the subscriber desires. A PDP context is a set of data elements that characterise a base transmission service. It includes parameters that allow a subscriber to communicate with a defined PDP address, according to a specific protocol and according to a specific quality of service profile (throughput, delay, priority, etc.)

This method is therefore applied when subscribers wish to send or receive data over the GPRS network in order to execute a service to which they have subscribed. It is triggered by the mobile subscriber and allows the terminal to be known from the GGSN service node that performs interconnection with the external network requested by the GPRS subscriber. When this PDP context activation method is completed, the corresponding quality service profile is exchanged between the various network nodes and the data transmission between the GPRS network and the external network corresponding to the service requested by the subscriber can then begin.

This method implements, in particular, the GTP protocol. During a first stage, the mobile terminal MS requests the creation of a GTP tunnel in the core network through which the data will be transmitted. During this request, it specifies the QoS requested by this tunnel.

The SGSN then performs the acceptance check. To do so, it compares the desired QoS with the (or one of the) subscribed QoS(s) that it has received during the connection method of the mobile terminal to the network. If the QoS requested by the subscriber exceeds the QoS subscribed to, the SGSN can refuse or modify the tunnel creation request, depending on a check that allows determining whether the requested resources are available or not at the SGSN level.

During a third phase, the SGSN relays the tunnel creation request to the GGSN with the QoS parameters from the check made by the SGSN. This is referred to as negotiated QoS. The ARP parameter is also transmitted to the GGSN by the SGSN during this stage.

The GGSN also performs, during a fourth phase, an acceptance check. This check allows determining, according to the negotiated QoS attributes, whether the requested resources are available or not at the GGSN level. If this is the case, then the acceptance function reserves the corresponding resources, and the GGSN acknowledges the request by the mobile terminal.

During a fifth phase, the SGSN accepts the request by the mobile terminal and sends the final QoS, the PFI parameter, and the RPL parameter to the mobile terminal.

At the end of this PDP context creation method, a GPRS tunnel is created between the SGSN and the GGSN that takes into account the QoS parameters negotiated with the subscriber.

A method called “Packet Flow Context” therefore consists in transferring the QoS parameters related to a data transfer from the SGSN to the BSS. All the data stored at the BSS level is standardised under the name “Packet Flow Context” or PFC and will be identified by the PFI in the various messages exchanged with the BSS.

The PFC includes, among other things, the following QoS parameters: “Precedence Class,” “Traffic Class,” “Traffic Handling Priority,” “Guaranteed Bit Rate,” and “Maximum Bit Rate.” The ARP parameter, in turn, is not stored at the BSS level.

Lastly, a special method called TBF Establishment is implemented for establishing the radio channel that the subscriber has to have available in order to send or receive data. The method for establishing TBF takes place when the terminal MS or the BSS have to transmit data over the radio interface and there are no existing channels between the specific mobile terminal and the BSS. Ascending TBF refers to data that is transmitted from the mobile terminal to the network, and descending TBF refers to the network to mobile terminal direction. The characteristics of the radio channel depend on the QoS parameters related to the subscriber and to the service corresponding to the data stream.

The method for activating a PDP context within the framework of the UMTS support service will now be considered.

As in the case of the GPRS framework, when PDP context is activated, the various nodes of the UMTS network receive the quality of service data defined according to the requested PDP context and the subscriber data stored at the HLR, which describe the services that the subscriber can access, with, in particular, the subscribed QoS and the ARP parameter.

That data corresponding to the subscriber priority level—that is, the ARP parameter contained in the data that defines the PDP context(s) to which the subscriber subscribes—is transmitted to the SGSN when the subscriber location is updated. This information is then transmitted to the GGSN when the subscriber activates the PDP context and then to the RNC.

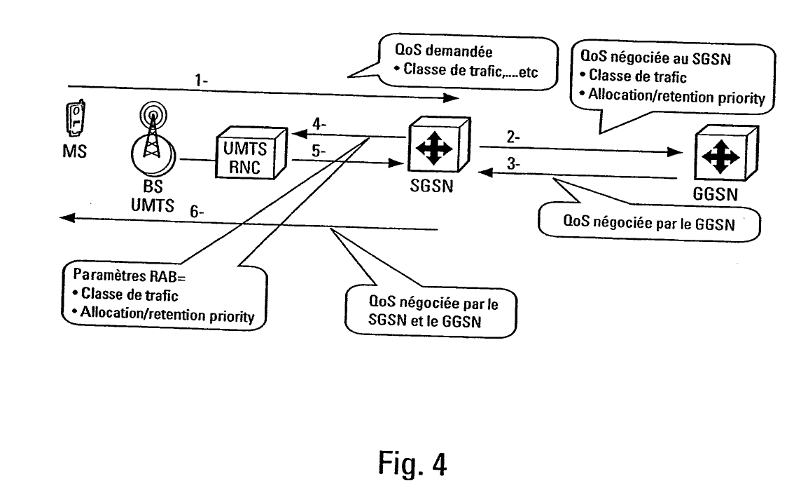

This method is described in detail with reference to FIG. 4.

During a first stage, the mobile terminal MS requests the activation of a PDP context to its connection SGSN, specifying the desired QoS. The SGSN can modify the desired QoS according to the data of the subscribe subscription, in particular. This is referred to as negotiated QoS.

During a second and third stage, the SGSN sends the request to the GGSN with the negotiated QoS. The GGSN can, in turn, modify or refuse the QoS and the QoS thus negotiated by the GGSN is returned to the SGSN.

During a fourth and fifth stage, the SGSN sends a request to the RNC to assign the necessary resources by describing the QoS in the form of RAB parameters. These parameters include, in particular, the traffic class in question and the ARP parameter. It should be noted that the RNC can accept or reject the requested RAB.

Lastly, a sixth stage consists in accepting the mobile terminal MS request by sending it the negotiated quality of service over the network.

Nevertheless, there can be several possible bottlenecks in GPRS/UMTS networks during the establishment and transfer of data. This relates to, in particular, SGSN, GGSN, and BSS/UTRAN equipment. Each of these has limited resources, whether in terms of available throughput, memory space, or processor load. It should be noted, however, that it is essentially the radio access (BSS/UTRAN) that is the limiting factor in the transfer of data over these types of networks.

Therefore, within a context of cost reduction, network resources and, notably, radio optimisation becomes critical when defining radio coverage with a capacity that is suitable to different types of supported traffic, whose passband and quality of service needs are very different. In particular, as already seen, the introduction of the Internet traffic requires to display networks adapted to both voice traffic and data traffic, whether real time or not.

This is why improving the management of the quality of service tends to become a major concern when considering the constraints of the mobile network and increasing its efficiency. Furthermore, because the perceived quality of service has an important impact on subscriber satisfaction, the capacity to ensure proper management of the quality of service will be seen as an important factor for differentiating between the various GPRS/UMTS operators.

A simple mechanism for managing quality of service when one of the network equipment is overloaded could consist in a “first in first serviced” type approach. But this type of approach is not satisfactory for a mobile operator, because it does not take into account the subscriber profile, nor the type of service requested. Using QoS parameters such as those defined above in the description is therefore anticipated.

Now, managing the quality of service based on the use of QoS parameters in GPRS or UMTS networks as it is applied today is not satisfactory. Notably, even if the QoS parameters as such are standardised, their use is not. The use of these QoS parameters in the network indeed results from the choice of implementation performed by the manufacturers of the various elements that comprise the network that are SGSN, GGSN, and BSC/RNC.

As a result, certain implementations exist at the GPRS/UMTS network element level, which provide processing based on only specific QoS parameters. The processing selected by manufacturers for managing QoS parameters can be a process related to the service requested by the subscriber, in order to favour, in case of network overloads, access to the resources and applications that are more constraining in terms of QoS, typically real time or multimedia applications. This differentiation is done mainly using the service-related QoS parameters, “Traffic Class” and “Traffic Handling Priority,” which are available, within the framework of the GPRS/UMTS networks in the SGSN, GGSN, and BSS/RNC, when the PDP context is activated.

It is also a known art to favour access to resources in case of a network overload for specific subscribers. This differentiation is done using a QoS parameter corresponding to a subscriber priority level. Within the framework of the GPRS network, this differentiation can be done, for example, using the ARP parameter for SGSN and GGSN, and using the “Precedence Class” parameter in BSS; whilst in the framework of the UMTS network, this differentiation can be done, for example, using the ARP parameter for SGSN and GGSN, and using the group of ARP parameters (“Priority Level,” “Pre-emption Capability,” “Pre-emption Vulnerability,” and “Queuing Allowed”) in RNC.

Thus, in all these implementations, the processing related to these QoS parameters is done in a linear fashion; that is, one after the other. Therefore, this results in quality of service management that is performed either according to the service, if the QoS parameters taken into account at the level of each node of the GPRS/UMTS network are mainly linked to the service, or according to the subscriber, if the QoS parameters taken into account at the level of each node of the GPRS/UMTS network are mainly linked to the subscriber.

The way the quality of service is currently managed in GPRS/UMTS networks therefore presents a significant limitation because it does not allow, for example, favouring resource access to real time applications, whilst maintaining non-real time application resources for priority subscribers.

The purpose of this invention is to solve these drawbacks by offering a method that allows adjusting quality of service management in packet switching mobile communications networks, such as GPRS/UMTS networks by taking into account the need to manage resource distribution over the network between the services and the subscribers.

This objective is achieved by the use of a quality of service management method that allows differentiating the quality of service over the network in the case of a network overload, based on a combined consideration of the QoS parameters related to the type of service and subscriber.

To this end, the invention relates to a quality of service management method in a packet mode mobile communications network, characterised in that, in order for the service to be executed by a subscriber to the network to which a data stream corresponds, it includes a stage that consists in determining an overall priority level associated to the data stream based on at least one quality of service parameter corresponding to a subscriber priority level and at least one quality of service parameter related to the type of service.

Advantageously, the method according to the invention includes a stage that consists in determining, based on said overall priority level, at least one quality of service process to be applied to the data stream.

Preferably, the method will include a stage that consists, in the case of a network overload, in applying the quality of service process to the data stream, by taking into account the overall priority level related to this data stream and the overall priority levels related to the data streams that correspond to other subscribers found on the network.

According to one embodiment, the overall priority level related to a data stream is determined according to a table that specifies an overall priority level value for each combination of two quality of service parameters that correspond, respectively, to a subscriber priority level and a service type.

Preferably, the network is managed by an operator, and the overall priority levels can be configured by said network operator.

Preferably, the mobile network includes a core network and an access network, and is implemented by at least one node of the group that includes a service node of the core network that ensures the management of the communication link with an access network, a service node of the core network that ensures the interconnection with an external network, and a management node of the access network radio resources.

Preferably, the quality of service parameter that corresponds to the subscriber priority level used for determining the overall priority level (NPG) includes one of the parameters of the group that includes:

the “Allocation Retention Priority” quality of service parameter,

the “Priority Level” sub-parameter of the “Allocation Retention Priority” quality of service parameter,

the “Precedence Class” quality of service parameter,

said quality of service sub-parameters and parameters are defined within the framework of the 3GPP telecommunications standard.

Preferably, the quality of service parameter related to the type of service used to determine the overall priority level (NPG) includes the parameter of quality of service ‘Traffic Class’, defined in the framework of the telecommunications 3GPP standard.

In a variant, the parameter of quality of service linked to the type of service used for the determination of the level of global priority (NPG) further includes the “Traffic Handling Priority” quality of service parameter, defined within the framework of the 3GPP telecommunications standard to associate a priority level to the data stream on the network when the data stream corresponds to an interactive type service.

The invention also relates to a device for implementing the method of the invention, and arranged, for the execution of a service by a subscriber of the network to which a data stream corresponds, in order to determine an overall priority level associated to the data stream according to at least one quality of service parameter that corresponds to a subscriber priority level and at least one quality of service parameter related to the type of service.

Advantageously, the device is arranged in order to determine, according to the overall priority level associated with a data stream, at least one quality of service process to be applied to this data stream.

Preferably, the device is arranged in order to apply a quality of service process to a data stream, whilst taking into account the overall priority level associated to this data stream and the overall priority levels associated to the data streams that correspond to other subscribers on the network.

According to one embodiment, the device is associated to a behaviour table that specifies a value of the overall priority level for each combination of two quality of service parameters corresponding, respectively, to a subscriber priority level and a type of service.

Advantageously, the overall priority levels can be configured by a network operator.

The invention also relates to a service node of a core network that ensures the management of the communication link with an access network, according to the device of the invention.

The invention also relates to a service node of a core network that ensures the interconnection with an external network, according to the device of the invention.

Lastly, the invention relates to a radio resource management node of an access network, according to the device of the invention.

The invention will be better understood, and other specificities and advantages will become apparent after reading the following description, given for illustration and non-limiting purposes; the description refers to the attached diagrams in which:

FIG. 1A, which has already been described, illustrates the architecture of a GPRS network;

FIG. 1B, which has also already been described, illustrates the architecture of a UMTS network;

FIG. 2, which has also already been described, illustrates the main stages of the method for connecting the mobile terminal to a GPRS type network;

FIG. 3, which has also already been described, illustrates the main stages of the method for activating a PDP context within the framework of a GPRS type network;

FIG. 4, which has also already been described, illustrates the main stages of the method for activating a PDP context within the framework of a UMTS type network;

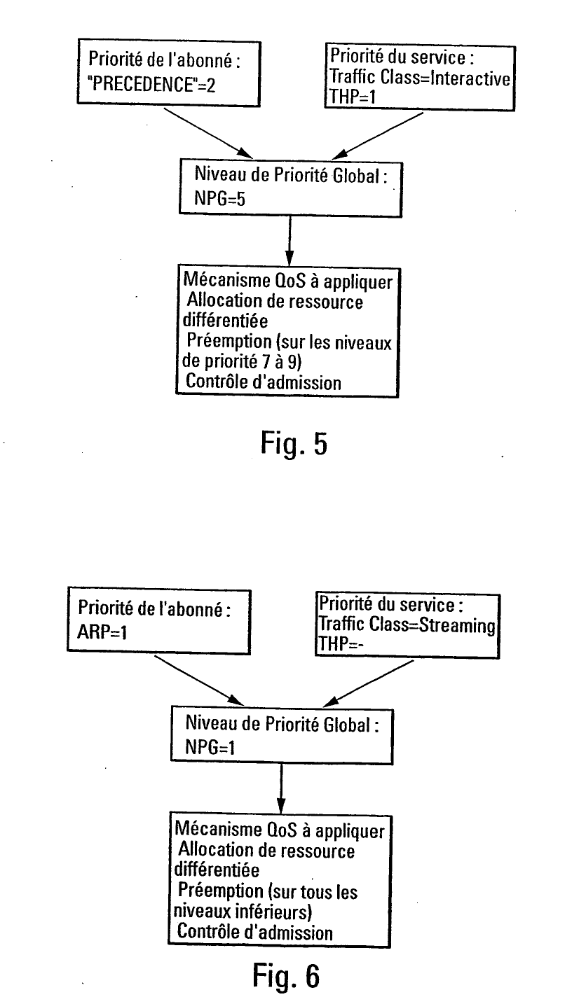

FIG. 5 illustrates a behaviour example, within the framework of the GPRS network, of the radio resource management node BSS according to an overall priority level determined according to the invention;

FIG. 6 illustrates a behaviour example, within the framework of the GPRS network, of the SGSN/GGSN service node according to an overall priority level determined according to the invention.

Firstly, the description of the invention will make reference to a GPRS type mobile communications network. The application of the UMTS network, in turn, implies certain differences in implementation that will be described later in the description. Nevertheless, the principle of the invention is similarly applicable to each of the types of networks indicated above.

Thus, the method of the invention allows giving priority in the processing of data streams based on priorities related to both the service and the subscriber. The fact that this prioritisation takes into account both the subscriber and the type of service allows giving priority to certain subscriber categories with respect to other subscribers whilst offering services that have different requirements in terms of throughput and delay. The mobile communications network operator will thus have significant flexibility in creating the offers targeted to its subscribers.

To do so, within the framework of the GPRS mobile communications network, in the case of a network overload when accessing resources for executing a service that corresponds to an activated PDP context, the quality of service management offered by the invention suggests combining at least the following QoS parameters:

“Allocation Retention Priority,” “Traffic Class,” and possibly “Traffic Handling Priority” at the SGSN and GGSN service node level of the core network, and

“Precedence Class,” “Traffic Class,” and possibly “Traffic Handling Priority” at the BSS radio resource management node level of the access network.

Thus, at the level of each of the BSS, SGSN, and GGSN nodes of the GPRS network, the quality of service management according to the inventions consists, in more general terms, in combining at least the QoS parameter related to a type of service, including, in particular, the “Traffic Class” QoS parameters and possibly the “Traffic Handling Priority” QoS parameters, with at least the quality of service parameter that corresponds to a subscriber priority level, including, in particular, the “Allocation Retention Priority” QoS parameter for the SGSN and GGSN service nodes, and the “Precedence Class” parameter for the BSS node.

Indeed, as seen previously in the description, within the framework of the GPRS network, the “Allocation Retention Priority” parameter is not transmitted to the BSS during the PFC method that involves transferring the QoS parameters related to a data stream from the SGSN to the BSS for an activated PDP context. Furthermore, according to an embodiment of the invention, a “Precedence Class” parameter is used at the BSS level, which is, in turn, transferred from the SGSN to the BSS during the PFC method, when it is used. This parameter will have the same value as the “Allocation Retention Priority” parameter and will define a subscriber priority level in the same manner.

It should also be noted that the “Traffic Class” and “Traffic Handling Priority” parameters are closely related; the latter is only used to indicate the priority level associated to a data stream when the latter corresponds to an interactive service type. Therefore, it is only used when the “Traffic Class” QoS parameter uses the Interactive value.

The quality of service management according to the invention based on this specific combination of QoS parameters allows establishing several priority levels for processing the different data streams on the network in case of a network overload. Advantageously, these priority levels can be configured by the network operator.

According to the invention, each of these configurable priority levels is associated with at least one predefined QoS process that can be used by each of the network nodes (BSS, SGSN, GGSN) to differentiate the access to resources in case of a network overload.

Several predefined QoS processes can be applied, for example:

acceptance control, which consists in checking whether the resources are available for establishing the call at the node level of the network in question. Thus, in case of a network overload and depending on the priority level associated with the data flow that was determined by the invention, the acceptance control process determines whether the request should be accepted or not;

pre-emption, which consists in the possibility of pre-empting the resources of another radio access support service (RAB). Thus, in case of an overload at a network node level, the latter is based on the priority level determined by the combination of QoS parameters according to the invention, in order to determine the subscribers with low priority level and force them to be removed from the network;

differentiated resource allocation, which consists in, in case of a network overload during the channel establishment request, and for each node of the network in question, taking into account the priority level determined by the combination of QoS parameters according to the invention in order to allocate a proportional throughput at this priority level.

The table below describes a list of behaviours by providing an example of the behaviour of the BSS within the framework of the GPRS, for quality of service management according to the invention. In this example, the table defines nine overall priority levels, each with a predefined quality of service process to be applied by the BSS. The behaviour table therefore identifies the QoS processes that the BSS must perform according to the overall priority level for accessing network resources, determined according to the invention, by taking into account both the QOS parameters related to the type of service (“Traffic Class;” “Traffic Handling Priority”) and the subscriber priority (“Precedence Class.”)

The BSS will be able to apply these mechanisms during the ascending or descending radio channel creation request.

### Behaviour Table at the BSS Level

| Over- | | | Value of | |
|---|---|---|---|---|
| all | Value of the | Value of | the “Traffic | |
| Pri- | “Precedence | the “Traffic | Handling | Quality of |
| ority | Class” QoS | Class” QoS | Priority” QoS | service process |
| Level | parameter | parameter | parameter | to be performed |
| 1 | 1 | “Conver- | — | Differentiated |
| | | sational” | | resource |
| | | | | allocation |
| | | | | Pre-emption (on |
| | | | | the lower overall |
| | | | | priority levels) |
| | | | | Acceptance |
| | | | | control |
| 2 | 1 | “Streaming | — | Differentiated |
| | 2 & 3 | “Conver- | — | resource |
| | | sational” | | allocation |
| | | | | Pre-emption (on |
| | | | | the lower overall |
| | | | | priority levels) |
| | | | | Acceptance |
| | | | | control |
| 3 | 2 & 3 | “Streaming” | — | Differentiated |
| | | | | resource |
| | | | | allocation |
| | | | | Pre-emption (on |
| | | | | the lower overall |
| | | | | priority levels) |
| | | | | Acceptance |
| | | | | control |
| 4 | 1 | “Inter- | 1 & 2 | Differentiated |
| | | active” | | resource |
| | | | | allocation |
| | | | | Pre-emption (on |
| | | | | the 7 to 9 |
| | | | | overall priority |
| | | | | levels) |
| | | | | Acceptance |
| | | | | control |
| 5 | 1 | “Inter- | 3 | Differentiated |
| | | active” | | resource |
| | 2 & 3 | “Inter- | 1 | allocation |
| | | active” | | Pre-emption (on |
| | | | | the 7 to 9 |
| | | | | overall priority |
| | | | | levels) |
| | | | | Acceptance |
| | | | | control |
| 6 | 2 & 3 | “Inter- | 2 & 3 | Differentiated |
| | | active” | | resource |
| | | | | allocation |
| | | | | Acceptance |
| | | | | control |
| 7 | 1 | “Back- | — | Differentiated |
| | | ground” | | resource |
| | | | | allocation |
| | | | | Acceptance |
| | | | | control |
| 8 | 2 | “Back- | — | Differentiated |
| | | ground” | | resource |
| | | | | allocation |
| | | | | Acceptance |
| | | | | control |
| 9 | 3 | “Back- | — | Differentiated |
| | | ground” | | resource |
| | | | | allocation |
| | | | | Acceptance |
| | | | | control |

In this example, the purpose is to create a Premium subscriber class corresponding to a value of the “Precedence” parameter equal to 1, whilst dividing the processing of services between real time (services supported by the “Conversational” and “Streaming” traffic classes) and non-real time (serviced supported by the “Interactive” and “Background” traffic classes.)

FIG. 5 illustrates the behaviour of the BSS with reference to the above behaviour table. In this example, access to the requested resources corresponds to a QoS profile stored at the BSS level; this profile is identified using the PFI parameter and contains the “Precedence Class” parameter with a value of “2”, whilst the “Traffic Class” and “Traffic Handling Priority” (THP) have the values “Interactive” and “1,” respectively. According to the invention, the combination of these QoS parameters corresponding, respectively, to a subscriber priority level and a priority level related to the type of service, allows determining an overall priority level NPG equal to 5 in this example.

According to the overall priority level equal to 5, the BSS must therefore apply the following QoS processes:

differentiated resource allocation

pre-emption on the overall priority levels 7 to 9, and

acceptance control

At the level of the SGSN and GGSN service nodes, the table below describes an example of the behaviour of these nodes for managing the quality of service according to the invention. This table defines five overall priority levels. It therefore identifies the QoS process to be performed by the SGSN and GGSN according to the overall priority level determined according to the invention, and at the same time, taking into account the QoS parameters related to the type of service (“Traffic Class;” “Traffic Handling Priority”) and the subscriber priority (“Allocation Retention Priority.”) At the level of these nodes, the QoS parameter corresponding to a subscriber priority level is the “Allocation Retention Priority” (ARP) parameter, and not the “Precedence” parameter as in the BSS.

Depending on the overall priority level, the SGSN and GGSN nodes must apply the QoS processes described in the table. The SGSN could apply these processes during the PDP context creation request.

### Behaviour Table at the SGSN/GGSN Level

| Over- | Value of the | | Value of | |
|---|---|---|---|---|
| all | “Allocation | Value of | the “Traffic | |
| Pri- | Retention | the “Traffic | Handling | |
| ority | Priority” QoS | Class” QoS | Priority” QoS | Process to be |
| Level | parameter | parameter | parameter | performed |
| 1 | 1 | “Conver- | — | Differentiated |
| | | sational” & | | resource |
| | | “Streaming” | | allocation |
| | | | | Pre-emption (on |
| | | | | the lower overall |
| | | | | priority levels) |
| | | | | Acceptance |
| | | | | control |
| 2 | 2 & 3 | “Conver- | — | Differentiated |
| | | sational” & | | resource |
| | | “Streaming” | | allocation |
| | | | | Pre-emption (on |
| | | | | the overall |
| | | | | priority levels |
| | | | | 4 and below) |
| | | | | Acceptance |
| | | | | control |
| 3 | 1 | “Inter- | 1 to 3 | Differentiated |
| | | active” | | resource |
| | | | | allocation |
| | | | | Acceptance |
| | | | | control |
| 4 | 2 | “Inter- | 1 to 3 | Differentiated |
| | | active” | | resource |
| | 3 | “Inter- | 1 | allocation |
| | | active” | | Acceptance |
| | | | | control |
| 5 | 1 to 3 | “Back- | — | Differentiated |
| | | ground” | | resource |
| | 3 | “Inter- | 2 & 3 | allocation |
| | | active” | | Acceptance |
| | | | | control |

In this example, the purpose is to give preference to subscribers with high priority; that is, those whose ARP parameter is equal to 1, and who can thus pre-empt all other subscribers for their real time service; that is, the services supported by the “Conversational” and “Streaming” traffic classes.

FIG. 6 therefore illustrates the behaviour of the SGSN/GGSN with reference to the table above. In this example, access to the requested resource corresponds to a QoS profile stored at the SGSN/GGSN level, in which the ARP parameter has a value of “1”, whilst the “Traffic Class” parameter has the value “Streaming,” and the “Traffic Handling Priority” (THP) parameter is not used. According to the invention, the combination of these QoS parameters corresponding, respectively, to a subscriber priority level and a priority level related to the type of service, allows determining an overall priority level NPG equal to 1 in this example.

According to this overall priority level equal to 1, the SGSN/GGSN must therefore apply the following predefined QoS processes:

differentiated resource allocation

pre-emption on all the overall priority levels lower than 9, and

acceptance control

Specifically, at the level of each BSS, SGSN, and GGSN node of the network, the utilisation of the data in the sample data tables is obtained using a quality of service differentiation algorithm implemented for the application of the predefined quality of service process. The input for this algorithm is therefore the values of the QoS parameter related to the type of service and subscriber and its output will be the QoS process that must be applied by the node in question, according to a combination of said QoS parameters.

It should be noted that in FIGS. 5 and 6, the overall priority levels determined by the specific combination of QoS parameters corresponding, on the one hand, to a priority level related to the type of service and, on the other, to a subscriber priority level, as with the QoS processes to be applied as a result, are only given for illustration purposes of an embodiment example. Other configuration options can, of course, be used according to the management strategy of the quality of service the operator chooses to use for the network, without leaving the framework of the present invention.

The application of the invention in a UMTS type mobile communications network will now be considered. In the case of a network overload when accessing resources for executing a service corresponding to an activated PDP context, the management of the quality of service according to the invention within the framework of the UMTS suggests combining at least the following QoS parameters:

“Allocation Retention Priority,” “Traffic Class,” and possibly “Traffic Handling Priority” at the SGSN and GGSN service node level of the core network, and

“Priority Level,” “Pre-emption Capability,” “Pre-emption Vulnerability,” “Queuing Allowed,” “Traffic Class,” and possibly “Traffic Handling Priority” at the RNC radio resource management node level of the access network.

Therefore, at the level of each of the RNC, SGSN, and GGSN nodes of the UMTS network, the management of the quality of service according to the invention consists, in general terms, in combining at least the QoS parameter related to the type of service, including, more specifically, the QoS parameters “Traffic Class” and possibly “Traffic Handling Priority,” with at least the quality of service parameter corresponding to a subscriber priority level, which includes the “Allocation Retention Priority” for the SGSN and GGSN service nodes and, more specifically, the “Priority Level” sub-parameter of the “Allocation Retention Priority” parameter for the RNC node.

Indeed, in the UTRAN, the “Allocation Retention Priority” (ARP) parameter comprises four sub-parameters: “Priority Level,” “Pre-emption Capability,” “Pre-emption Vulnerability,” and “Queuing Allowed.” It is the SGSN that, upon receiving the ARP parameter from the HLR assigns the values to the sub-parameters. The ARP is sent to the GGSN during the PDP context creation method. On the other hand, the sub-parameters are the ones that are sent to the RNC, and in particular, it is the “Priority Level” sub-parameter that will be used in the UTRAN at the RNC level to assign a priority level to the subscriber.

Despite this slight difference in implementation, the principles indicated above in the embodiment example applied to a GPRS type network remain unchanged.

An example of the UMTS network is shown, in which the three subscriber categories are defined:

Category 1: ARP=1 in the HLR

Category 2: ARP=2 in the HLR, and

Category 3: ARP=3 in the HLR

In this network, the desired outcome, in the case of a network overload at the radio level, is to implement a predefined QoS process in which the non-real time services of Category 1 subscribers pre-empts the non-real time services of Category 3 subscribers. Thus, at the level of each network node, the following quality of service differentiation algorithm is implemented for the application at the level of each node of the predefined pre-emption process:

IF(“Traffic Class”=Interactive OR “Traffic Class”=Background) AND (ARP=1)

THEN PRE-EMPTION (“Traffic Class”=Interactive OR “Traffic Class”=Background) AND (ARP=3)

Here, ARP is considered as the “Allocation Retention Priority” parameter when the SGSN and GGSN nodes are taken into account, and as the “Priority Level” sub-parameter when the RNC node is taken into account.

The input of this algorithm is therefore the values of the QoS parameter related to the type of service (“Traffic Class”) and the subscriber (ARP), and its output is the QoS processes that should be applied by the node in question according to a combination of said QoS parameters.

Other predefined QoS processes can also be used, depending on the quality of service management strategy chosen by the UMTS network operator.

A QoS process can consists in, for example in the case of a network overload, that the real time services can pre-empt the non-real time service resources, except if these resources have been allocated to Gold subscribers.

The following quality of service differentiation algorithm is therefore implemented for applying this predefined QoS processes at the level of each node:

IF(“Traffic Class”=Streaming OR “Traffic Class”=Conversational) THEN PRE-EMPTION (“Traffic Class”=Interactive OR “Traffic Class”=Background) AND (ARP=3 OR ARP=2)

Advantageously, through the invention, it is now possible to ensure the allocation of the necessary resources to provide adequate service for a so-called priority subscriber, whilst respecting, according to the services, the needs of other subscribers. The invention therefore allows better management of the quality of service in the case of network overload, owing to the combined consideration, for allocating resources at the level of each network node, of the QoS parameters corresponding to a priority level related to the service type and quality of service parameters corresponding to the subscriber priority level.

### Glossary

This glossary provides a list of English acronyms used in this patent application. These acronyms are defined within the framework of the 3GPP telecommunications standard.
3GPP Third-Generation Partnership Project (of ETSI)
ETSI European Telecommunications Standards Institute
GPRS General Packet Radio Service
GSM Global System for Mobile Communication
UMTS Universal Mobile Telecommunication System
IP Internet Protocol
BTS Base Transceiver Station
BSC Base Station Controller
BSS Base Station Subsystem
HLR Home Location Register
SGSN Serving GPRS Support Node
GGSN Gateway GPRS Support Node
UTRAN UMTS Terrestrial Radio Access Network
RNC Radio Network Controller
QoS Quality of Service
FTP File Transfer Protocol
ARP Allocation Retention Priority
PDP Packet Data Protocol
THP Traffic Handling Priority
IMSI International Mobile Subscriber Identity
PFC Packet Flow Context
PFI Packet Flow Identifier
RPL Radio Priority Level
TBF Temporary Block Flow
RAB Radio Access Bearer
GTP GPRS Tunnelling Protocol
MAP Mobile Application Part

1. Quality of service management method in a packet mode mobile communication network, characterised in that, in order for a service to be executed by a subscriber to the network to which a data stream corresponds, it includes a stage that consists in determining an overall priority level (NPG) associated to the data stream based on at least one quality of service parameter corresponding to a subscriber priority level and at least one quality of service parameter related to the type of service.

2. Method according to claim 1, characterised in that it includes a stage that consists in determining, based on said overall priority level (NPG), at least one quality of service process to be applied to the data stream.

3. Method according to claim 2, characterised in that it includes a stage that consists in, in the case of a network overload, applying said quality of service process to the data stream, taking into account the overall priority level related to this data stream and the overall priority levels related to the data streams that correspond to other subscribers found on the network.

4. Method according to claim 3, characterised in that the overall priority level related to a data stream is determined according to a table that specifies an overall priority level value for each combination of the two quality of service parameters that correspond, respectively, to a subscriber priority level and a service type.

5. Method according to claim 4, characterised in that the network is managed by an operator, and the overall priority levels can be configured by said network operator.

6. Method according to claim 1, characterised in that the mobile network includes a core network (RC) and an access network (RA, UTRAN) and is implemented by at least some nodes of the group that includes a service node (SGSN) of the core network that ensures the management of the communication link with an access network, a service node (GGSN) of the core network that ensures the interconnection with an external network, and a management node of the access network radio resources (BSS/RNC).

7. Method according to claim 1, characterised in that the quality of service parameter that corresponds to the subscriber priority level used for determining the overall priority level (NPG) includes one of the parameters of the group that includes:
the “Allocation Retention Priority” quality of service parameter,
the “Priority Level” sub-parameter of the “Allocation Retention Priority” quality of service parameter,
the “Precedence Class” quality of service parameter,
said quality of service sub-parameters and parameters are defined within the framework of the 3GPP telecommunications standard.

8. Method according to claim 1, characterised in that the quality of service parameter related to the type of service used to determine the overall priority level (NPG) includes the “Traffic Class” quality of service parameter, defined within the framework of the 3GPP telecommunications standard.

9. Method according to claim 8, characterised in that the quality of service parameter related to the type of service used to determine the overall priority level (NPG) further includes the “Traffic Handling Priority” quality of service parameter, defined within the framework of the 3GPP telecommunications standard to associate a priority level to the data stream on the network when the data stream corresponds to an interactive type service.

10. Device for implementing the method of claim 1, arranged, for the execution of a service by a subscriber of the network to which a data stream corresponds, in order to determine an overall priority level (NPG) associated to the data stream according to at least one quality of service parameter that corresponds to a subscriber priority level and at least one quality of service parameter related to the type of service.

11. Device according to claim 10, characterised in that it is arranged in order to determine, according to the overall priority level (NPG) associated with a data stream, at least one quality of service process to be applied to this data stream.

12. Device according to claim 10, characterised in that it is arranged in order to apply a quality of service process to a data stream, whilst taking into account the overall priority level associated to this data stream and the overall priority levels associated to the data streams that correspond to other subscribers on the network.

13. Device according to claim 10, characterised in that it associated to a behaviour table that specifies a value of the overall priority level for each combination of the two quality of service parameters corresponding, respectively, to a subscriber priority level and a type of service.

14. Device according to claim 10, characterised in that the overall priority levels can be configured by a network operator.

15. Service node (SGSN) of a core network (RC) that ensures the management of the communication link with the access network (RA, UTRAN) according to the device of claim 10.

16. Service node (GGSN) of a core network (RC) that ensures the interconnection with an external network, according to the device of claim 10.

17. Radio resource management node (BSS/RNC) of an access network, according to the device of claim 10.
